(19) United States
(12) Patent Application Publication
(10) Pub. No.: US 2018/0374500 A1
(43) Pub. Date: Dec. 27, 2018

(54) Voice Activity Detection Using A Soft Decision Mechanism

(71) Applicant: Verint Systems Ltd., Herzliya Pituach (IL)

(72) Inventor: Ron Wein, Ramat Hasharon (IL)

(21) Appl. No.: 15/959,743

(22) Filed: Apr. 23, 2018

Related U.S. Application Data
(63) Continuation of application No. 14/449,770, filed on Aug. 1, 2014, now Pat. No. 9,984,706.
(60) Provisional application No. 61/861,178, filed on Aug. 1, 2013.

(51) Int. Cl. G10L 25/78

(52) U.S. Cl. CPC G10L 25/78

(57) ABSTRACT

Voice activity detection (VAD) is an enabling technology for a variety of speech based applications. Herein disclosed is a robust VAD algorithm that is also language independent. Rather than classifying short segments of the audio as either “speech” or “silence”, the VAD as disclosed herein employees a soft-decision mechanism. The VAD outputs a speech-presence probability, which is based on a variety of characteristics.

### CROSS REFERENCE TO RELATED APPLICATIONS

This application is a continuation of U.S. patent application Ser. No. 14/449,770, filed on Aug. 1, 2014, which claims the benefit of U.S. Provisional Application No. 61/861,178, filed Aug. 1, 2013. The contents of these applications are hereby incorporated by reference in their entirety.

### BACKGROUND

Voice activity detection (VAD), also known as speech activity detection or speech detection, is a technique used in speech processing in which the presence or absence of human speech is detected. The main uses of VAD are in speech coding and speech recognition. VAD can facilitate speech processing, and can also be used to deactivate some processes during identified non-speech sections of an audio session. Such deactivation can avoid unnecessary coding/transmission of silence packets in Voice over Internet Protocol (VOIP) applications, saving on computation and on network bandwidth.

### SUMMARY

Voice activity detection (VAD) is an enabling technology for a variety of speech-based applications. Herein disclosed is a robust VAD algorithm that is also language independent. Rather than classifying short segments of the audio as either “speech” or “silence”, the VAD as disclosed herein employees a soft-decision mechanism. The VAD outputs a speech-presence probability, which is based on a variety of characteristics.

In one aspect of the present application, a method of detection of voice activity in audio data, the method comprises obtaining audio data, segmenting the audio data into a plurality of frames, computing an activity probability for each frame from the plurality of features of each frame, compare a moving average of activity probabilities to at least one threshold, and identifying a speech and non-speech segments in the audio data based upon the comparison.

In another aspect of the present application, a method of detection of voice activity in audio data, the method comprises obtaining a set of segmented audio data, wherein the segmented audio data is segmented into a plurality of frames, calculating a smoothed energy value for each of the plurality of frames, obtaining an initial estimation of a speech presence in a current frame of the plurality of frames, updating an estimation of a background energy for the current frame of the plurality of frames, estimating a speech present probability for the current frame of the plurality of frames, incrementing a sub-interval index .mu. modulo U of the current frame of the plurality of frames, and resetting a value of a set of minimum tracers.

In another aspect of the present application, a non-transitory computer readable medium having computer executable instructions for performing a method comprises obtaining audio data, segmenting the audio data into a plurality of frames, computing an activity probability for each frame from the plurality of features of each frame, compare a moving average of activity probabilities to at least one threshold, and identifying a speech and non-speech segments in the audio data based upon the comparison.

In another aspect of the present application, a non-transitory computer readable medium having computer executable instructions for performing a method comprises obtaining a set of segmented audio data, wherein the segmented audio data is segmented into a plurality of frames, calculating a smoothed energy value for each of the plurality of frames, obtaining an initial estimation of a speech presence in a current frame of the plurality of frames, updating an estimation of a background energy for the current frame of the plurality of frames, estimating a speech present probability for the current frame of the plurality of frames, incrementing a sub-interval index .mu. modulo U of the current frame of the plurality of frames, and resetting a value of a set of minimum tracers.

In another aspect of the present application, a method of detection of voice activity in audio data, the method comprises obtaining audio data, segmenting the audio data into a plurality of frames, calculating an overall energy speech probability for each of the plurality of frames, calculating a band energy speech probability for each of the plurality of frames, calculating a spectral peakiness speech probability for each of the plurality of frames, calculating a residual energy speech probability for each of the plurality of frames, computing an activity probability for each of the plurality of frame from the overall energy speech probability, band energy speech probability, spectral peakiness speech probability, and residual energy speech probability, comparing a moving average of activity probabilities to at least one threshold, and identifying a speech and non-speech segments in the audio data based upon the comparison.

### BRIEF DESCRIPTION OF THE DRAWINGS

FIG. 1 is a flowchart that depicts an exemplary embodiment of a method of voice activity detection.

FIG. 2 is a system diagram of an exemplary embodiment of a system for voice activity detection.

FIG. 3 is a flow chart that depicts an exemplary embodiment of a method of tracing energy values.

### DETAILED DISCLOSURE

Most speech-processing systems segment the audio into a sequence of overlapping frames. In a typical system, a 20-25 millisecond frame is processed every 10 milliseconds. Such speech frames are long enough to perform meaningful spectral analysis and capture the temporal acoustic characteristics of the speech signal, yet they are short enough to give fine granularity of the output.

Having segmented the input signal into frames, features, as will be described in further detail herein, are identified within each frame and each frame is classified as silence/speech. In another embodiment, the speech-presence probability is evaluated for each individual frame. A sequence of frames that are classified as speech frames (e.g. frames having a high speech-presence probability) are identified in order to mark the beginning of a speech segment. Alternatively, a sequence of frames that are classified as silence frames (e.g. having a low speech-presence probability) are identified in order to mark the end of a speech segment.

As disclosed in further detail herein, energy values over time can be traced and the speech-presence probability estimated for each frame based on these values. Additional information regarding noise spectrum estimation is provided by I. Cohen. Noise spectrum estimation in adverse environment: Improved Minima Controlled Recursive Averaging. IEEE Trans. on Speech and Audio Processing, vol. 11(5), pages 466-475, 2003, which is hereby incorporated by reference in its entirety. In the following description a series of energy values computed from each frame in the processed signal, denoted E₁ E₂, K, E_{T} is assumed. All Eₜ values are measured in dB. Furthermore, for each frame the following parameters are calculated:
Sₜ—the smoothed signal energy (in dB) at time t.
τₜ—the minimal signal energy (in dB) traced at time t.
τₜ^{(u)}—the backup values for the minimum tracer, for 1≤u≤U (U is a parameter).
Pₜ—the speech-presence probability at time t.
Bₜ—the estimated energy of the background signal (in dB) at time t.

The first frame is initialized S₁, τ₁, τ₁^{(u)} (for each 1≤u≤U), and B₁ is equal to E₁ and P₁=0. The index u is set to be 1.

For each frame t>1, the method 300 is performed.

At 302 the smoothed energy value is computed and the minimum tracers (0<α_{S}<1 is a parameter) are updated, exemplarily by the following equations:

Sₜ=α_{S}·Sₜ₋₁+(1−α_{S})·Eₜ

τₜ=min(τₜ₋₁,Sₜ)

τₜ^{(u)}=min(τₜ₋₁^{(u)},Sₜ)

Then at 304, an initial estimation is obtained for the presence of a speech signal on top of the background signal in the current frame. This initial estimation is based upon the difference between the smoothed power and the traced minimum power. The greater the difference between the smoothed power and the traced minimum power, the more probable it is that a speech signal exists. A sigmoid function

$$Σ ( x ; μ , σ ) = \frac{1}{1 + {e}^{σ \cdot ( μ - x )}}$$

can be used, where μ,σ are the sigmoid parameters:

q=Σ(Sₜ−τₜ;μ,σ)

Next, at 306, the estimation of the background energy is updated. Note that in the event that q is low (e.g. close to 0), in an embodiment an update rate controlled by the parameter 0<α_{B}<1 is obtained. In the event that this probability is high, a previous estimate may be maintained:

β=α_{B}+(1−α_{B})·\sqrt{q}

Bₜ=β·Eₜ₋₁+(1−β)·Sₜ

The speech-presence probability is estimated at 308 based on the comparison of the smoothed energy and the estimated background energy (again, μ,σ are the sigmoid parameters and 0<α_{P}<1 is a parameter):

p=Σ(Sₜ−Bₜ;μ,σ)

Pₜ=α_{P}·Pₜ₋₁+(1−α_{P})·p

In the event that t is divisible by V (V is an integer parameter which determines the length of a sub-interval for minimum tracing), then at 310, the sub-interval index u modulo U (U is the number of sub-intervals) is incremented and the values of the tracers are reset at 312:

$${τ}_{t} = {min}_{1 \leq v \leq U} \{ {τ}_{t}^{( v )} \}$$

$${τ}_{t}^{( u )} = {S}_{t}$$

In embodiments, this mechanism enables the detection of changes in the background energy level. If the background energy level increases, (e.g. due to change in the ambient noise), this change can be traced after about U·V frames.

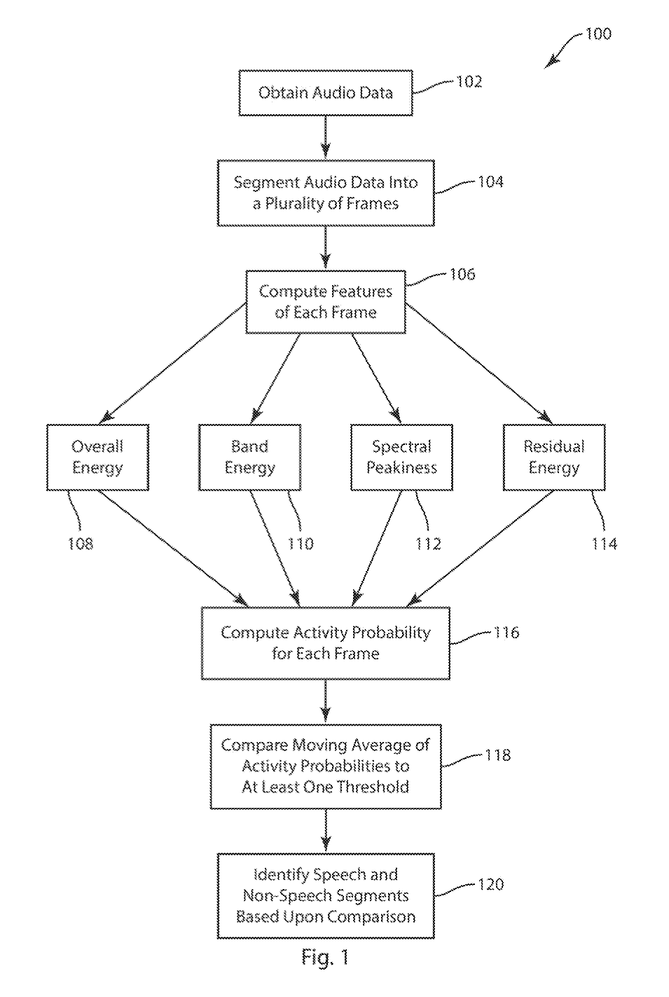

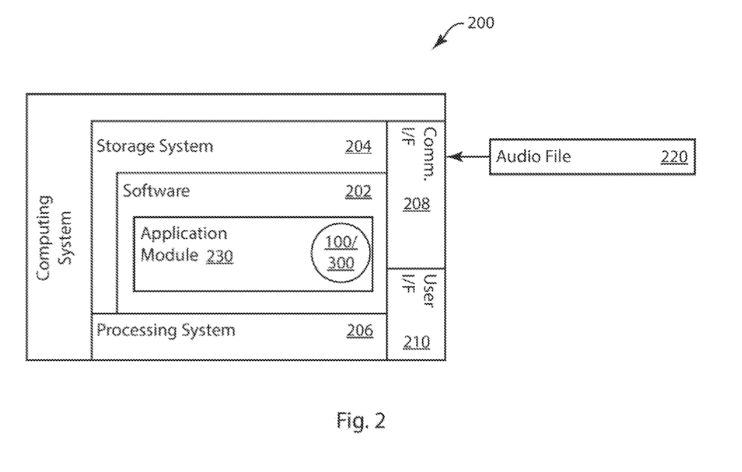

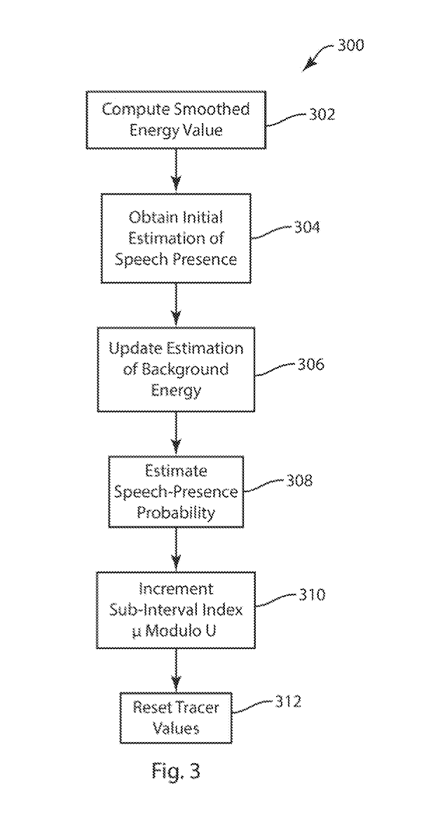

FIG. 1 is a flow chart that depicts an exemplary embodiment of a method 100 or method 300 of voice activity detection. FIG. 2 is a system diagram of an exemplary embodiment of a system 200 for voice activity detection. The system 200 is generally a computing system that includes a processing system 206, storage system 204, software 202, communication interface 208 and a user interface 210. The processing system 206 loads and executes software 202 from the storage system 204, including a software module 230. When executed by the computing system 200, software module 230 directs the processing system 206 to operate as described in herein in further detail in accordance with the method 100 of FIG. 1, and the method 300 of FIG. 3.

Although the computing system 200 as depicted in FIG. 2 includes one software module in the present example, it should be understood that one or more modules could provide the same operation. Similarly, while description as provided herein refers to a computing system 200 and a processing system 206, it is to be recognized that implementations of such systems can be performed using one or more processors, which may be communicatively connected, and such implementations are considered to be within the scope of the description.

The processing system 206 can comprise a microprocessor and other circuitry that retrieves and executes software 202 from storage system 204. Processing system 206 can be implemented within a single processing device but can also be distributed across multiple processing devices or sub-systems that cooperate in existing program instructions. Examples of processing system 206 include general purpose central processing units, applications specific processors, and logic devices, as well as any other type of processing device, combinations of processing devices, or variations thereof.

The storage system 204 can comprise any storage media readable by processing system 206, and capable of storing software 202. The storage system 204 can include volatile and non-volatile, removable and non-removable media implemented in any method or technology for storage of information, such as computer readable instructions, data structures, program modules, or other data. Storage system 204 can be implemented as a single storage device but may also be implemented across multiple storage devices or sub-systems. Storage system 204 can further include additional elements, such a controller capable, of communicating with the processing system 206.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In some implementations, the store media can be a non-transitory storage media. In some implementations, at least a portion of the storage media may be transitory. It should be understood that in no case is the storage media a propogated signal.

User interface 210 can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a video display or graphical display can display an interface further associated with embodiments of the system and method as disclosed herein. Speakers, printers, haptic devices and other types of output devices may also be included in the user interface 210.

As described in further detail herein, the computing system 200 receives a audio file 220. The audio file 220 may be an audio recording or a conversation, which may exemplarily be between two speakers, although the audio recording may be any of a variety of other audio records, including multiples speakers, a single speaker, or an automated or recorded auditory message. The audio file may exemplarily be a .WAV file, but may also be other types of audio files, exemplarily in a post code modulation (PCM) format and an example may include linear pulse code modulated (LPCM) audio filed, or any other type of compressed audio. Furthermore, the audio file is exemplary a mono audio file; however, it is recognized that embodiments of the method as disclosed herein may also be used with stereo audio files. In still further embodiments, the audio file may be streaming audio data received in real time or near-real time by the computing system 200.

In an embodiment, the VAD method 100 of FIG. 1 exemplarily processes frames one at a time. Such an implantation is useful for on-line processing of the audio stream. However, a person of ordinary skill in the art will recognize that embodiments of the method 100 may also be useful for processing recorded audio data in an off-line setting as well.

Referring now to FIG. 1, the VAD method 100 may exemplarily begin at step 102 by obtaining audio data. As explained above, the audio data may be in a variety of stored or streaming formats, including mono audio data. At step 104, the audio data is segmented into a plurality of frames. It is to be understood that in alternative embodiments, the method 100 may alternatively begin receiving audio data already in a segmented format.

Next, at 106, one or more of a plurality of frame features are computed. In embodiments, each of the features are a probability that the frame contains speech, or a speech probability. Given an input frame that comprises samples x₁, x₂, K, x_{F} (wherein F is the frame size), one or more, and in an embodiment, all of the following features are computed.

At 108, the overall energy speech probability of the frame is computed. Exemplarily the overall energy of the frame is computed by the equation:

$$\overline{E} = 10 \cdot {log}_{10} ( {\sum }_{k = 1}^{F} {( {x}_{k} )}^{2} )$$

As explained above with respect to FIG. 3, the series of energy levels can be traced. The overall energy speech probability for the current frame, denoted as p_{E} can be obtained and smoothed given a parameter 0<α<1:

\tilde{p}_{E}=α·\tilde{p}_{E}+(1−α)·p_{E}

Next, at step 110, a band energy speech probability is computed. This is performed by first computing the temporal spectrum of the frame (e.g. by concatenating the frame to the tail of the previous frame, multiplying the concatenated frames by a Hamming window, and applying Fourier transform of order N). Let X₀, X₁, K, X_{N/2} be the spectral coefficients. The temporal spectrum is then subdivided into bands specified by a set of filters H₀^{(b)}, H₁^{(b)}, K, H_{N/2}^{(b)} for 1≤b≤M (wherein M is the number of bands; the spectral filters may be triangular and centered around various frequencies such that ΣₖHₖ^{(b)}=1). Further detail of one embodiment is exemplarily provided by I. Cohen, and B. Berdugo. Spectral enhancement by tracking speech presence probability in subbands. Proc. International Workshop on Hand-free Speech Communication (HSC'01), pages 95-98, 2001, which is hereby incorporated by reference in its entirety. The energy level for each band is exemplarily computed using the equation:

$${E}^{( b )} = 10 \cdot {log}_{10} ( {\sum }_{k = 0}^{\frac{N}{2}} {H}_{k}^{( b )} \cdot {\vert {X}_{k} \vert}^{2} )$$

The series of energy levels for each band is traced, as explained above with respect to FIG. 3. The band energy speech probability P_{B} for each band in the current frame, which we denote p^{(b)} is obtained, resulting in:

$${p}_{B} = \frac{1}{M} \cdot {\sum }_{b = 1}^{M} {p}^{( b )}$$

At 112, a spectral peakiness speech probability is computed A spectral peakiness ratio is defined as:

$$ρ = \frac{{\sum }_{k : \vert {X}_{k} \vert > \vert {X}_{k - 1} \vert , \vert {X}_{k + 1} \vert} {\vert {X}_{k} \vert}^{2}}{{\sum }_{k = 0}^{\frac{N}{2}} {\vert {X}_{k} \vert}^{2}}$$

The spectral peakiness ratio measures how much energy in concentrated in the spectral peaks. Most speech segments are characterized by vocal harmonies, therefore this ratio is expected to be high during speech segments. The spectral peakiness ratio can be used to disambiguate between vocal segments and segments that contain background noises. The spectral peakiness speech probability p_{P} for the frame is obtained by normalizing ρ by a maximal value ρₘₐₓ (which is a parameter), exemplarily in the following equations:

$${p}_{P} = \frac{ρ}{{ρ}_{max}}$$

$${\tilde{p}}_{P} = α \cdot {\tilde{p}}_{P} + ( 1 - α ) \cdot {p}_{P}$$

At step 114, the residual energy speech probability for each frame is calculated. To calculate the residual energy, first a linear prediction analysis is performed on the frame. In the linear prediction analysis given the samples x₁, x₂, K, x_{F} a set of linear coefficients a₁, a₂, K, a_{L} (L is the linear-prediction order) is computed, such that the following expression, known as the linear-prediction error, is brought to a minimum:

$$ɛ = {\sum }_{k = 1}^{F} {( {x}_{k} - {\sum }_{i = 1}^{L} {a}_{i} \cdot {x}_{k - i} )}^{2}$$

The linear coefficients may exemplarily be computed using a process known as the Levinson-Durbin algorithm which is described in further detail in M. H. Hayes. Statistical Digital Signal Processing and Modeling. J. Wiley & Sons Inc., New York, 1996, which is hereby incorporated by reference in its entirety. The linear-prediction error (relative to overall the frame energy) is high for noises such as ticks or clicks, while in speech segments (and also for regular ambient noise) the linear-prediction error is expected to be low. We therefore define the residual energy speech probability (P_{R}) as:

$${p}_{R} = {( 1 - \frac{ɛ}{{\sum }_{k = 1}^{F} {( {x}_{k} )}^{2}} )}^{2}$$

$${\tilde{p}}_{R} = α \cdot {\tilde{p}}_{R} + ( 1 - α ) \cdot {p}_{R}$$

After one or more of the features highlighted above are calculated, an activity probability Q for each frame cab be calculated at 116 as a combination of the speech probabilities for the Band energy (P_{B}), Total energy (P_{E}), Energy Peakiness (P_{P}), and Residual Energy (P_{R}) computed as described above for each frame. The activity probability (Q) is exemplarily given by the equation:

Q={square root over (p_{B}·max{\tilde{p}_{E},\tilde{p}_{P},\tilde{p}_{R})}}

It should be noted that there are other methods of fusing the multiple probability values (four in our example, namely p_{B}, p_{E}, and p_{R}) into a single value Q. The given formula is only one of many alternative formulae. In another embodiment, Q may be obtained by feeding the probability values to a decision tree or an artificial neural network.

After the activity probability (Q) is calculated for each frame at 116, the activity probabilities (Qₜ) can be used to detect the start and end of speech in audio data. Exemplarily, a sequence of activity probabilities are denoted by Q₁, Q₂, K, Q_{T}. For each frame, let \hat{Q}ₜ be the average of the probability values over the last L frames:

$${\hat{Q}}_{t} = \frac{1}{L} \cdot {\sum }_{k = 0}^{L - 1} {Q}_{t - k}$$

The detection of speech or non-speech segments is carried out with a comparison at 118 of the average activity probability \hat{Q}ₜ to at least one threshold (e.g. Qₘₐₓ, Qₘᵢₙ). The detection of speech or non-speech segments co-believed as a state machine with two states, “non-speech” and “speech”:

Start from the “non-speech” state and t=1

Given the tth frame, compute Qₜ and the update \hat{Q}ₜ

Act according to the current state
If the current state is “no speech”:
Check if \hat{Q}ₜ>Qₘₐₓ. If so, mark the beginning of a speech segment at time (t−k), and move to the “speech” state.
If the current state is “speech”:
Check if \hat{Q}ₜ<Qₘᵢₙ. If so, mark the end of a speech segment at time (t−k), and move to the “no speech” state.

Increment t and return to step 2.

Thus, at 120 the identification of speech or non-speech segments is based upon the above comparison of the moving average of the activity probabilities to at least one threshold. In an embodiment, Qₘₐₓ therefore represents an maximum activity probability to remain in a non-speech state, while Qₘᵢₙ represents a minimum activity probability to remain in the speech state.

In an embodiment, the detection process is more robust then previous VAD methods, as the detection process requires a sufficient accumulation of activity probabilities over several frames to detect start-of-speech, or conversely, to have enough contiguous frames with low activity probability to detect end-of-speech.

Traditional VAD methods are based on frame energy, or on band energies. In the suggested methods, the system and method of the present application also takes into consideration additional features such as residual LP energy and spectral peakiness. In other embodiments, additional features may be used, which help distinguish speech from noise, where noise segments are also characterized by high energy values:
Spectral peakiness values are high in the presence of harmonics, which are characteristic to speech (or music). Car noises and bubble noises, for example, are not harmonic and therefore have low spectral peakiness; and
High residual LP energy is characteristic for transient noises, such as clicks, bangs, etc.

The system and method of the present application uses a soft-decision mechanism and assigns a probability with each frame, rather than classifying it as either 0 (non-speech) or 1 (speech):

obtains a more reliable estimation of the background energies; and
It is less dependent on a single threshold for the classification of speech/non-speech, which leads to false recognition of non-speech segments if the threshold is too low, or false rejection of speech segments if it is too high. Here, two thresholds are used (Q.sub.min and Q.sub.max in the application), allowing for some uncertainty. The moving average of the Q values make the system and method switch from speech to non-speech (or vice versa) only when the system and method are confident enough.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for identifying non-speech segments in audio data to avoid processing the non-speech segments, the method comprising:
obtaining audio data;
segmenting the audio data into a sequence of frames;
calculating an activity probability for each frame in the sequence, wherein the activity probability corresponds to a probability that the frame contains speech;
determining, frame-by-frame, a state of each frame in the sequence as either speech or non-speech by comparing a moving average of activity probabilities for a group of frames, including the frame, to a selected threshold, wherein the selected threshold for a particular frame depends on the determined state of a frame proceeding the particular frame in the sequence;
identifying non-speech segments in the audio data based upon the determined states of the frames; and
deactivating subsequent processing of the non-speech segments in the audio data.

2. The method according to claim 1, wherein the selected threshold for a frame following a non-speech frame is a maximum activity probability, which the moving average must exceed for the state of the frame to be determined as speech.

3. The method according to claim 1, wherein the selected threshold for a frame following a speech frame is a minimum activity probability, which the moving average must be below for the state of the frame to be determined as non-speech.

4. The method according to claim 1, wherein the activity probability for a frame is a combination of a plurality of different speech probabilities computed using the audio data of the frame.

5. The method according to claim 4, wherein the plurality of different speech probabilities comprises:
an overall energy speech probability based on an overall the energy of the audio data;
a band energy speech probability based on an energy of the audio data contained within one or more spectral bands;
a spectral peakiness speech probability based on an energy of the audio data that is concentrated in one or more spectral peaks; and
a residual energy speech probability based on a residual energy resulting from a linear prediction of the audio data.

6. The method according to claim 5, wherein the overall energy speech probability, the band energy speech probability, the spectral peakiness probability and the residual energy speech probability each have a value between 0 and 1, wherein 0 corresponds to non-speech and 1 corresponds to speech.

7. The method according to claim 6, wherein the activity probability is the square root of the band energy speech probability multiplied by the largest of the overall energy probability, the spectral peakiness probability, and the residual energy probability.

8. The method according to claim 1, wherein each non-speech segment corresponds to audio data in one or more consecutive non-speech frames bordered in the sequence by speech frames.

9. The method according to claim 1, further comprising:
identifying speech segments in the audio data based upon the determined states of the frames; and
activating subsequent processing of the speech segments in the audio data.

10. The method according to claim 9, wherein each speech segment corresponds to audio data in one or more consecutive speech frames bordered in the sequence by non-speech frames.

11. A non-transitory computer readable medium containing computer readable instructions that when executed by a processor of a computing device cause the computing device to perform a method for identifying non-speech segments in audio data to avoid processing the non-speech segments, the method comprising:
obtaining audio data;
segmenting the audio data into a sequence of frames;
calculating an activity probability for each frame in the sequence, wherein the activity probability corresponds to a probability that the frame contains speech;
determining, frame-by-frame, a state of each frame in the sequence as either speech or non-speech by comparing a moving average of activity probabilities for a group of frames, including the frame, to a selected threshold, wherein the selected threshold for a particular frame depends on the determined state of a frame proceeding the particular frame in the sequence;
identifying non-speech segments in the audio data based upon the determined states of the frames; and
deactivating subsequent processing of the non-speech segments in the audio data.

12. The non-transitory computer readable medium according to claim 11, wherein the selected threshold for a frame following a non-speech frame is a maximum activity probability, which the moving average must exceed for the state of the frame to be determined as speech.

13. The non-transitory computer readable medium according to claim 11, wherein the selected threshold for a frame following a speech frame is a minimum activity probability, which the moving average must be below for the state of the frame to be determined as non-speech.

14. The non-transitory computer readable medium according to claim 11, wherein the activity probability for a frame is a combination of a plurality of different speech probabilities computed using the audio data of the frame.

15. The non-transitory computer readable medium according to claim 14, wherein the plurality of different speech probabilities comprises:
an overall energy speech probability based on an overall the energy of the audio data;
a band energy speech probability based on an energy of the audio data contained within one or more spectral bands;
a spectral peakiness speech probability based on an energy of the audio data that is concentrated in one or more spectral peaks; and
a residual energy speech probability based on a residual energy resulting from a linear prediction of the audio data.

16. The non-transitory computer readable medium according to claim 15, wherein the overall energy speech probability, the band energy speech probability, the spectral peakiness probability and the residual energy speech probability each have a value between 0 and 1, wherein 0 corresponds to non-speech and 1 corresponds to speech.

17. The non-transitory computer readable medium according to claim 16, wherein the activity probability is the square root of the band energy speech probability multiplied by the largest of the overall energy probability, the spectral peakiness probability, and the residual energy probability.

18. The non-transitory computer readable medium according to claim 11, wherein each non-speech segment corresponds to audio data in one or more consecutive non-speech frames bordered in the sequence by speech frames.

19. The non-transitory computer readable medium according to claim 11, further comprising:
identifying speech segments in the audio data based upon the determined states of the frames; and
activating subsequent processing of the speech segments in the audio data.

20. The non-transitory computer readable medium according to claim 19, wherein each speech segment corresponds to audio data in one or more consecutive speech frames bordered in the sequence by non-speech frames.
